(19) United States
(12) Patent Application Publication
(10) Pub. No.: US 2026/0268312 A1
(43) Pub. Date: Sep. 10, 2026

(54) SECURITY SYSTEM FOR REAL ESTATE TRANSACTIONS

(71) Applicant: Peter Russo, Boca Raton, FL (US)

(72) Inventor: Peter Russo, Boca Raton, FL (US)

(21) Appl. No.: 19/382,428

(22) Filed: Nov. 7, 2025

Related U.S. Application Data
(60) Provisional application No. 63/718,355, filed on Nov. 8, 2024.

(51) Int. Cl. G06Q 20/38; G06Q 20/30; G06Q 20/40; G06Q 40/02

(52) U.S. Cl. CPC G06Q 20/3821; G06Q 20/305; G06Q 20/4016; G06Q 40/0222; G06Q 40/024; G06Q 40/026; G06Q 2220/00

(57) ABSTRACT

This invention relates to a method for securely integrating and managing multiple bank accounts for members within a software platform. The method leverages machine learning and artificial intelligence to optimize the entry and validation of bank account information, significantly reducing errors and enhancing security. In operation, a Member (title company or anyone asking for wiring instructions) initiates a request within their Member account, needing only the recipient's name and phone number. The recipient is prompted to log in to the system using two-factor authentication sent to their cell phone. Once authenticated, they securely enter wiring instructions through System platform. The system then transmits the instructions to the Command Center of the Member, allowing easy transfer to a CSV file or integration with their bank's cash management system.

### PRIORITY CLAIM

In accordance with 37 C.F.R. 1.76, a claim of priority is included in an Application Data Sheet filed concurrently herewith. This application claims the priority date of U.S. Provisional Patent Application No. 63/718,355 entitled “SECURITY SYSTEM FOR REAL ESTATE TRANSACTIONS”, filed Nov. 8, 2024, the contents of which is incorporated herein by reference in its entirety.

### FIELD OF THE INVENTION

This invention relates to the field of cyber security and in particular to a method for securely integrating and managing multiple bank accounts leveraging artificial intelligence to optimize Member security, significantly reducing errors, and allowing an operating system enhanced efficiency and accuracy.

### BACKGROUND OF THE INVENTION

During real estate transactions, title companies wire the seller's proceeds, often based on instructions from the seller's agent. Cybercriminals hack into agents' email accounts and wait for the chance to intercept the process. Posing as the agent, they send fake emails just before closing, requesting a change in the seller's wiring instructions, diverting funds to their own accounts. In 2020-2021, wire fraud cost the industry $893 million. Security is a critical concern in the banking sector. With the increase in cyberattacks and data breaches, ensuring the accuracy and security of banking information is paramount. Customers need assurance that their sensitive data is protected from unauthorized access and potential compromise. However, current methods of validating bank details often lack real-time feedback mechanisms that would allow for immediate error detection and correction, leaving room for fraudulent activities or data breaches.

In modern banking, account management and the process of adding or updating accounts involve multiple steps that are often susceptible to various errors and security vulnerabilities. The manual handling of bank account information, as well as outdated verification systems, create significant risks, including incorrect data entry, unauthorized access, and mismanagement of funds. Financial institutions, customers, and businesses frequently face issues such as delays in transaction processing, incorrect account details, and exposure to fraud.

One of the main challenges lies in the sharing and submission of bank information. Often, customers are required to manually input sensitive banking details, which increases the likelihood of human errors, such as entering incorrect account numbers or routing information. These mistakes can lead to failed transactions, misdirected funds, and a need for extensive customer service intervention to rectify the issues. In a digital age where instant access to funds and seamless transactions are essential, the existing manual processes are insufficient and prone to inefficiencies.

In response to these challenges, there is a growing need for enhanced systems that can ensure real-time validation of banking information. Incorporating machine learning (ML) algorithms and artificial intelligence (AI) into the validation process offers a promising solution. AI and ML technologies can rapidly analyze and verify the accuracy of account details, monitor transaction statuses in real time, and detect any inconsistencies or potential security threats. By integrating intelligent algorithms into banking systems, institutions can provide a more robust and secure method of handling sensitive financial data while improving the customer experience.

For instance, real-time validation of bank balances and transaction statuses would enable users to make faster, more informed decisions regarding their financial activities. This could be achieved through a mechanism that cross-references account data against existing financial records and security protocols, flagging any anomalies or discrepancies for immediate review. Such a system would significantly reduce the margin for error and improve the overall efficiency of banking processes, making it easier to manage accounts without compromising on security.

In summary, the current landscape of banking systems is fraught with challenges related to accuracy, security, and efficiency. There is a clear need for advanced, AI-driven mechanisms that can address these issues by providing real-time validation and safeguarding against errors and fraud. The integration of machine learning algorithms and artificial intelligence into banking processes offers a revolutionary way to enhance account management and transaction verification, leading to a more secure and streamlined financial system.

### SUMMARY OF THE INVENTION

This invention relates to a method for securely integrating and managing multiple bank accounts for members of a software program. A member (title company or anyone asking for wiring instructions) initiates a request within their member account, needing only the recipient's name, email, and phone number. The recipient receives an email prompting them to log in to program using two-factor authentication sent to their cell phone. Once authenticated, the member securely enters wiring instructions through an online platform. The system then transmits the instructions to a Command Center of the member, allowing easy transfer to a CSV file or integration with their bank's cash management system.

The process leverages machine learning and artificial intelligence to optimize the entry and validation of bank account information, significantly reducing errors and enhancing. Provides a secure method for members to request bank information from individuals both within and outside the software platform. The process integrates advanced anomaly detection, automated notifications, and state-of-the-art encryption to ensure data integrity and security. Member of the software program can share their bank details securely with individuals, both within and outside a software platform. The system employs predefined sharing mechanisms, automated validation checks, and secure authentication processes to enhance data integrity and user security. Members may initiate and manage bank transfers securely providing detailed recipient information and ensures real-time validation of bank balances and transaction status.

An objective of the invention is to provide an advanced, AI-driven banking system providing real-time validation and safeguarding against errors and fraud. The enhanced account management and transaction verification, leading to a more secure and streamlined financial system.

Another objective of the invention is to provide a method for managing multiple bank accounts that is highly secure and eliminates human error from manual data entry.

Still another objective of the invention is to provide a system that is fast, with 1-click information capture for quick bank processing, and utilizes proprietary AI integration for enhanced efficiency and accuracy

Other objectives and advantages of this invention will become apparent from the following description taken in conjunction with any accompanying flow diagrams wherein are set forth, by way of illustration and example, certain embodiments of this invention. Any flow diagrams contained herein constitute a part of this specification and include exemplary embodiments of the present invention and illustrate various features thereof.

### BRIEF DESCRIPTION OF THE DRAWINGS

FIG. 1 is a flow diagram for Adding Bank Information;

FIG. 2 is a flow diagram to Request Bank Information;

FIG. 3 is a flow diagram to Send Bank Information;

FIG. 4 is a flow diagram for Generating Bank Transfers;

FIG. 5 is a flow diagram for the wire transfer system architecture.

### DETAILED DESCRIPTION OF THE PREFERRED EMBODIMENT

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

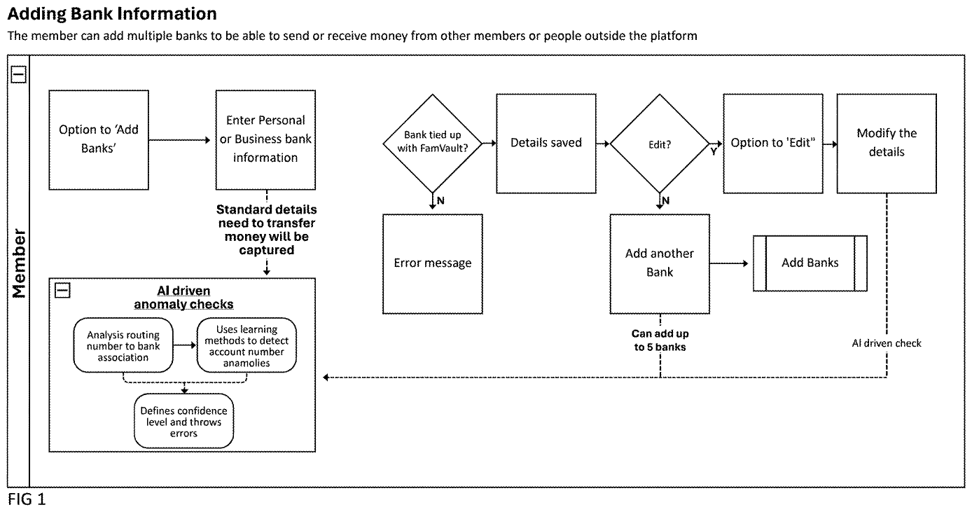

Referring now to FIG. 1, set forth is a secure method for adding bank information wherein members can securely add up to five bank accounts. Each bank account is associated with specific details including Routing Number, Account Number, and other relevant information. The data entry procedure is designed to adhere to the highest security standards, ensuring that sensitive member information is protected. Obtain routing number and account number for a bank account addition through a computer system connected to the internet.

Machine Learning and Artificial Intelligence Utilization: The system employs machine learning algorithms and artificial intelligence techniques to analyze and understand: Relationships between routing numbers and their corresponding banks, Common formats and patterns in the account numbers provided by members. By leveraging these technologies, the process aims to: Identify and correct discrepancies in real-time and enhance the accuracy of bank account information entry.

Error Reduction Mechanism: The innovative use of machine learning aids in drastically reducing anomalies that may occur during the input of bank information. This results in: Improved data integrity, Streamlined user experience when managing bank details, Increased overall reliability of the member's account information. Through this method, the invention ensures that members can securely and efficiently manage their bank accounts, reducing operational errors and enhancing user trust. Minimize the likelihood of errors during the addition and management of bank account details. Machine learning and artificial intelligence to analyze and understand relationships between routing numbers and corresponding banks, Common formats and patterns in the account numbers provided by members.

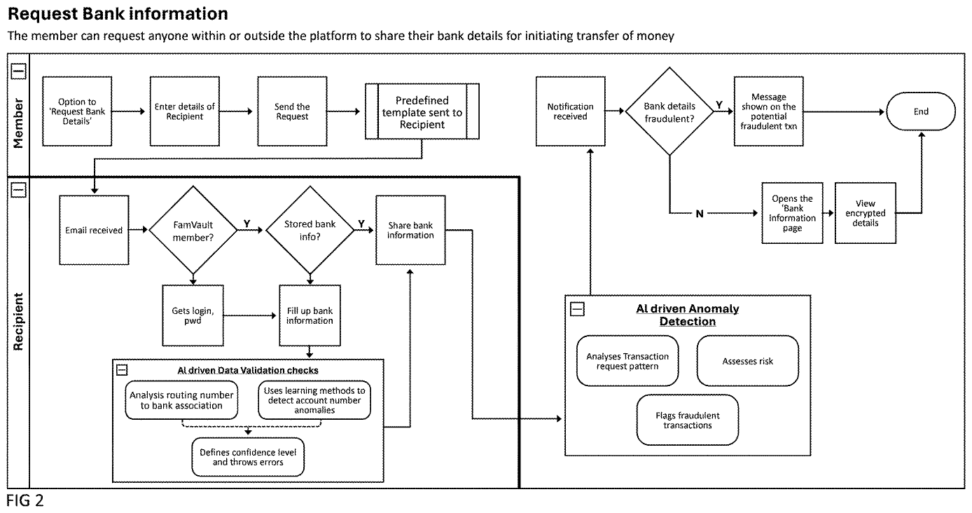

Referring now to FIG. 2, set forth is a secure method for members to request bank information from individuals both within and outside a software platform. The process integrates advanced anomaly detection, automated notifications, and state-of-the-art encryption to ensure data integrity and security.

Bank Information Request Mechanism: Members can initiate requests for bank information from any individual, regardless of whether they are part of the platform. The member simply provides necessary details about the requester, including email Address and Phone Number. Leveraging said relationships to identify and correct discrepancies in real-time wherein accuracy of bank account information is minimized during the addition and management of bank account details. Adopting machine learning aids to reduce anomalies that may occur during the input of bank information to improve data integrity and reliability of the member's account information.

AI for Data Validation: The platform incorporates an artificial intelligence driven Data validation feature. This ensures that the bank details submitted through the request form are validated for accuracy. Regardless of whether the sender is within or outside the platform, this feature verifies that the data entered meets the platform's security standards, thereby safeguarding against data compromise. Incorporate an artificial intelligence driven data validation feature to ensure that bank details submitted through the request form are validated for accuracy and verifies that the data entered meets the platform's security standards.

Automated Notification and Access: Once the requested bank details are successfully sent to the member, the system automates the notification process. The member is promptly informed and can access the provided information directly through the platform. Provide automated notification and access wherein a member is promptly informed and can access the provided information.

Secure Data Storage: All bank details are stored using advanced encryption and decryption techniques, ensuring maximum security. £ Additionally, data presented on the user interface is appropriately masked to protect sensitive information from unauthorized access. Encrypting of bank details to maximize security and mask sensitive information from unauthorized access.

Immutable Data Storage: The system employs a Quantum Ledger Database (QLDB) to store bank details, ensuring that the information is immutable and cannot be altered retroactively. This enhances data integrity and accountability. Employing a Quantum Ledger Database (QLDB) to store bank details.

Risk Assessment for Incoming Data: An additional layer of security involves the application of machine learning algorithms to assess the transaction risk associated with incoming data. This process evaluates potential risks and flags suspicious data, preventing it from being entered into the system. Through these features, the invention ensures that members can securely request and manage bank information while maintaining the highest standards of data integrity and security. Application of a machine learning algorithms to assess the transaction risk associated with incoming data.

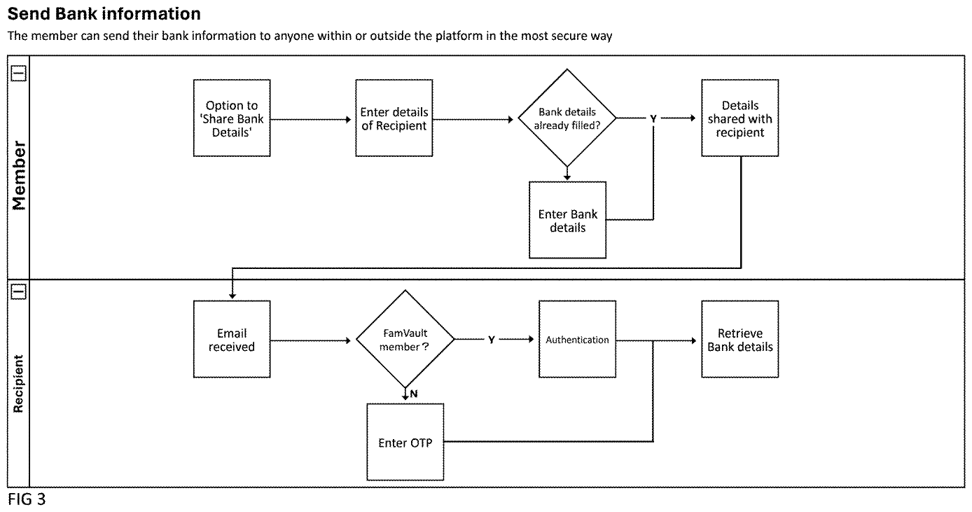

Referring to FIG. 3, set forth is a method for members to share their bank details securely with individuals, both within and outside a software platform. The system employs predefined sharing mechanisms, automated validation checks, and secure authentication processes to enhance data integrity and user security.

Bank Information Sharing Mechanism: The platform enables members to share their bank details with anyone who requests this information, regardless of whether the requester is part of the platform. Evaluating potential risks and flags suspicious data, preventing it from being entered into the system.

Predefined Sharing Feature: Members are encouraged to utilize a predefined feature that allows for the secure storage and sharing of bank information. This feature standardizes the process, making it easier for members to share their information with requesters. Sharing bank information with anyone who requests the information.

Flexible Data Entry: Even if members opt not to use the predefined feature, the platform provides a way to allow members to fill in the necessary bank information directly before sending it to the requester. Providing a platform for filling in the necessary bank information directly before sending it to the requester. Comparing data against a predefined feature that allows for the secure storage and sharing of bank information.

Automated Data Validation: Each time a member adds or edits their bank information, the system automatically triggers machine learning-based data validation checks. This ensures that any issues or errors in the information being provided are identified and addressed in real time. Automated data validation by a machine learning-based data validation checks to ensures that any errors in the information are identified and addressed in real time.

Secure Onboarding for Recipients: Once a member shares their bank information, the recipient receives a secure email invitation to onboard as a software platform member. This step adds an additional layer of security, ensuring that sensitive information is shared only with verified users. Securing an email invitation to onboard as a member ensuring that sensitive information is shared only with verified users.

Secure Authentication Process: Access to the member's bank details is only granted after the recipient successfully completes a secure authentication process. This guarantees that only authorized individuals can view the shared information. Through these feature, the invention provides a robust framework for secure and efficient sharing of bank information while maintaining high standards of data protection and user authentication. Authentication mechanism granting access to the member's bank details only after a recipient successfully completes a secure authentication process.

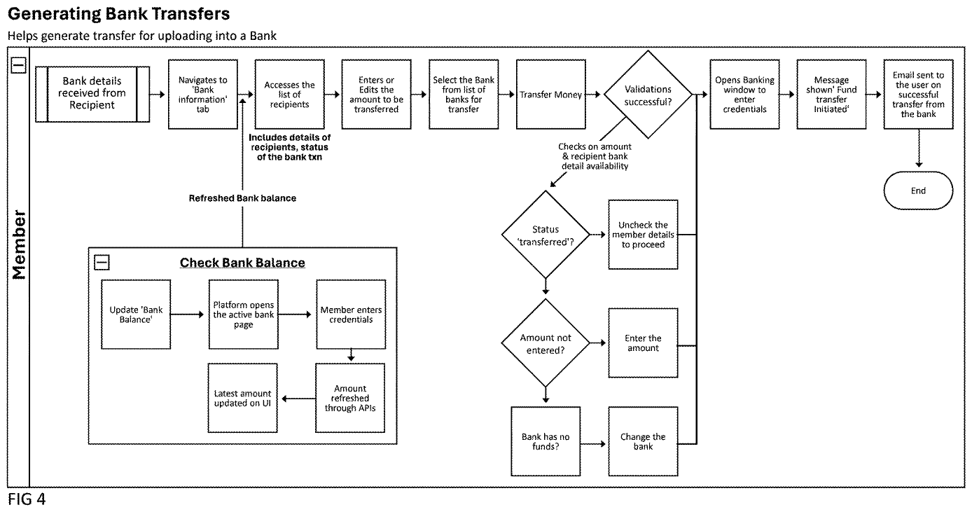

Referring to FIG. 4, set forth is a method for members to initiate and manage bank transfers securely. The system facilitates the selection of transactions, provides detailed recipient information, and ensures real-time validation of bank balances and transaction status. Transaction Selection Interface: Members have the capability to select specific transactions they wish to initiate for bank transfers. This feature streamlines the process and allows for targeted financial activities. Generating bank transfers by selecting specific transactions for bank transfers.

Recipient Information Display: The software platform displays relevant recipient data, including Recipient's Name, Phone Number, Email Address. Members can enter the transfer amount directly on this page, ensuring clarity and ease of use. Additionally, the platform provides real-time status updates, allowing members to see whether transactions have been completed or are currently in progress. Display relevant recipient data including recipient's name, phone number and email address.

Real-Time Bank Balance Retrieval: Members can request the latest bank balance for the selected bank account via an ad-hoc request. This retrieval occurs through the bank's secure platform, requiring member authentication to access sensitive information. Entering transfer amount with real-time status updates to see whether transactions have been completed or are currently in progress.

Real-Time Bank Balance Retrieval: Members can request the latest bank balance for the selected bank account via an ad-hoc request. This retrieval occurs through the bank's secure platform, requiring member authentication to access sensitive information. Retrieval of real time bank balance retrieval for a selected bank account via an ad-hoc request requiring member authentication to access sensitive information.

Bank Selection and Multi-Recipient Capability: When initiating a transfer, members can choose the bank based on the most recent balance information. The system also allows for multiple recipients to be selected for a single bank transfer, enhancing flexibility in managing transactions. Initiating a transfer based on the most recent balance information, validation of a bank transfer through several checks.

Transaction Validation Checks: Upon initiation of a bank transfer, the system performs several automated checks, including: Verification of sufficient funds in the member's account, confirmation that the transfer status is valid, identification of any missing required inputs verification of sufficient funds in the account, confirmation that the transfer status is valid, identification of missing required inputs, notification of transfer fund status, confirmation of transfer fund and providing an overview of the transaction status.

Notifications for Transfer Status: The platform notifies members upon the successful initiation of the bank transfer. Furthermore, members receive confirmation once the funds have been transferred, providing a comprehensive overview of the transaction status. This enhances the user experience by combining transaction management, real-time data access, and robust validation processes, ensuring secure and efficient bank transfers.

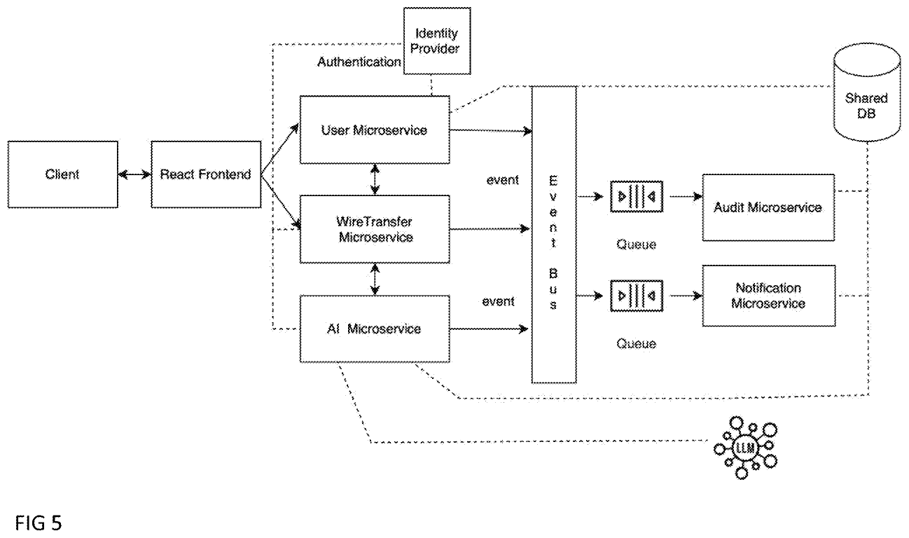

Referring to FIG. 5 a Browser Interface, powered by a React-based frontend, serves as the gateway for customers to interact with the platform. The interface is designed with a focus on security and seamless user experience, allowing users to input and manage banking information through a responsive interface. Transport Layer Security (TLS) is used to safeguard all communications to backend services, ensuring that sensitive information remains protected throughout the transaction process.

The User Microservice handles multi-factor authentication (MFA) to ensure that only verified users can manage or initiate transactions. The Microservice integrates with the AWS Cognito Identity provider to manage user profiles and authentication securely. Upon successful login, AWS Cognito generates a JSON Web Token (JWT), which serves as a digital proof of the user's identity and authentication status. This token is securely transmitted back to the client over TLS-encrypted channels, ensuring it cannot be intercepted or tampered with during transit. The React frontend then includes this JWT token in the Authorization Header of each subsequent request it sends to the backend services. This seamless integration between the frontend, Cognito, and backend services ensures secure, verified communication throughout the user's session.

The Wire Transfer Microservice is responsible for securely managing all aspects of bank information and wire transfer operations. It facilitates adding, requesting, sending bank information, and executing bank transfers, while maintaining stringent security and compliance protocols. The Wire Transfer Microservice ensures the security and integrity of user interactions by validating JWT tokens received from the React frontend. This process confirms that users are authenticated, and their sessions are valid, preventing unauthorized access. The tokens are verified for authenticity by checking their signatures, which AWS Cognito's built-in mechanisms streamline, enabling seamless user authentication. After authentication, a Role-Based Access Control (RBAC) check authorizes the user's actions, ensuring they have the appropriate permissions to add or manage bank details. CORS configurations are set up to ensure that only legitimate cross-origin requests are processed, effectively reducing the attack surface for potential vulnerabilities.

Each user can store up to five different bank accounts in their profile. When adding or updating information such as account numbers and routing numbers, the Wire Transfer Microservice calls the AI Microservice for Intelligent Data Validation and Auto-Correction. All information is transmitted through Transport Layer Security (TLS)-encrypted channels and further protected by AES SHA-256 symmetric encryption managed via AWS Key Management Service (KMS). Once securely encrypted, the banking data is stored in a database with encryption at rest, safeguarding sensitive information from unauthorized access.

When a user needs to request bank information, they provide the recipient's contact details, such as email address and phone number. This information, along with the request details, is transmitted securely over TLS-encrypted channels. Upon validation, the system sends a secure email to the recipient, including a link directing them to the platform, where they can submit the requested bank details. To maintain security, the recipient must undergo a secure authentication process, including Multi-Factor Authentication (MFA), before providing their information. Once submitted, the bank details are encrypted using AES SHA-256 encryption and stored in a Quantum Ledger Database (QLDB), ensuring data immutability and cryptographic verifiability. The Wire Transfer Microservice leverages the AI Microservice for Intelligent Data Validation and Auto-Correction. Every interaction is logged by the Audit Microservice, creating a comprehensive, immutable audit trail for enhanced security and compliance.

The platform also supports the secure sharing of bank information. Users log in using MFA to access a predefined sharing feature, allowing them to manage and share their stored bank details. Robust security controls ensure that only the bank details corresponding to the authenticated user are accessible, preventing unauthorized access. Users also have the option to manually enter bank information, which is encrypted for secure transmission over TLS channels. Machine learning-based validation checks are applied to ensure the accuracy of the data before it is shared. Once ready, a secure email with a link is sent to the recipient, prompting them to undergo an onboarding process that includes MFA and identity verification before accessing the shared information. Sensitive data remains encrypted at rest, using SHA-256 encryption managed by AWS KMS, and is securely stored in a database. Every action, including data validation, sharing, and access, is meticulously logged by the Audit Microservice and stored in QLDB, preserving integrity, compliance, and traceability.

The Wire Transfer Microservice is designed to facilitate secure, efficient management of bank transfers. Through the Transaction Selection Interface, users can initiate transfers by selecting specific transactions and entering the transfer amount. The platform displays detailed recipient information, including name, phone number, and email address, ensuring clarity and transparency for the user. The system supports multi-recipient transfers, enabling users to select multiple recipients for a single transaction, based on verified account balances. Before executing a transfer, the system calls the AI Microservice to perform automated validation checks using machine learning models and real-time rule-based algorithms. These checks confirm sufficient funds, validate all necessary inputs, and verify the legitimacy of the transfer, thereby reducing the risk of errors or fraudulent activities.

Users receive continuous real-time updates on the transaction status, and notifications are sent upon successful initiation and completion of the transfer. All transaction activities, including data exchanges, validations, and transfers, are logged by the Audit Microservice, creating a tamper-proof, cryptographically verifiable trail stored in QLDB. This ensures compliance, integrity, and transparency throughout the wire transfer process.

The AI Microservice enhances the wire transfer process through several features, ensuring security and efficiency. AI-Powered Anomaly Detection and Fraud Prevention: Analyzes wire transfer requests in real-time to identify and mitigate potential fraudulent activities; Learns normal transaction patterns for each account and continuously updates its model based on new data and feedback′; Flags high-risk transactions for review, allowing administrators to take necessary actions.

AI-Driven Optimal Transfer Scheduling and Batching: Analyzes historical transfer data for patterns in processing times and fee structures; Predicts cost-effective and efficient times for initiating transfers, suggesting optimal batching of multiple transfers to reduce fees and processing time; Generates an optimized CSV file with scheduled transfer instructions, adapting recommendations based on real-time feedback. Intelligent Data Validation and Auto-Correction: Validates routing and account numbers against known patterns and databases, ensuring data accuracy before processing; Detects and corrects common typos and formatting errors, verifying consistency between bank name and routing number; Suggests corrections for detected errors, learning from user corrections to improve future suggestions.

Audit Microservice is responsible for tracking and recording all significant events and actions within the system. It acts as a log, maintaining a detailed record of activities, which helps in monitoring and troubleshooting. Events from various services like the User Microservice, Wire Transfer Microservice, and AI Microservice are sent to the Audit Microservice. This microservice collects data such as login attempts, transaction initiations, and changes in user information. The stored data can be used for: Security Audits to ensure compliance and trace unauthorized access; Investigation: to investigate incidents by tracking user actions; System Monitoring to monitor system health and performance.

The Notification Microservice is designed to handle all system notifications, sending alerts and updates to users or administrators based on specific events. The Notification Microservice listens to the event bus, which receives information from multiple microservices about specific actions (e.g., successful transactions, suspicious transaction patterns flagged by machine learning algorithms, sensitive data access or modifications etc). This service ensures that users are kept informed of critical updates and system events, improving communication and user experience.

The method provides for securely managing user authentication and wire transfer operations via a browser interface, comprising:

Providing a browser interface implemented using a React-based frontend for user interaction, wherein the interface enables users to securely input and manage banking information through a responsive design, and communication between the frontend and backend services is encrypted using Transport Layer Security (TLS) to prevent unauthorized access to sensitive data.

Implementing a User Microservice configured to perform multi-factor authentication (MFA) to verify the identity of users, wherein the microservice is integrated with AWS Cognito, and upon successful authentication, AWS Cognito generates a JSON Web Token (JWT), the JWT being transmitted back to the browser interface via TLS-encrypted channels, wherein the JWT is included in subsequent requests from the frontend in the Authorization Header for verification by the backend services.

Providing a Wire Transfer Microservice configured to validate the JWT tokens received from the React frontend to confirm that the user's session is authenticated and valid by verifying the token's signature using AWS Cognito's built-in mechanisms, b. Perform Role-Based Access Control (RBAC) checks to authorize user actions for adding or managing bank account details based on predefined permissions.

Storing up to five bank accounts per user within the Wire Transfer Microservice, wherein banking information, including account numbers and routing numbers, is transmitted over TLS-encrypted channels and further encrypted using AES SHA-256 symmetric encryption managed by AWS Key Management Service (KMS), the encrypted banking data being stored in a database with encryption at rest to ensure protection against unauthorized access.

Facilitating secure requests for bank information, wherein users provide recipient contact details, and the Wire Transfer Microservice: transmitting of secure emails or messages to recipients, including a link directing them to the platform, wherein recipients are required to undergo a secure authentication process including MFA before submitting their banking information, and encrypting and stores submitted bank information using AES SHA-256 encryption in a Quantum Ledger Database (QLDB) to ensure cryptographic verifiability and data immutability.

Supporting secure sharing of bank information through a predefined sharing feature, wherein users access the feature after undergoing MFA authentication, and the shared banking information is encrypted during transmission, with machine learning-based validation checks applied to ensure data accuracy before sharing, and the system sends secure notifications to the intended recipient with MFA onboarding for access.

Enabling users to initiate wire transfers through a Transaction Selection Interface, wherein: the system verifies inputs, such as transaction amount and recipient details, using a machine learning-based validation engine, performing checks for sufficient funds and confirming the legitimacy of the transfer, and multi-recipient wire transfers are supported, allowing users to select multiple recipients in a single transaction based on verified account balances.

Providing real-time transaction status updates and

### Notifications, Wherein Users Are Notified Upon Successful

initiation and completion of wire transfers, and all transaction activities, including validations, banking data exchanges, and transfer operations, are securely logged by an Audit Microservice, with the logs stored in a Quantum Ledger Database (QLDB) for tamper-proof, cryptographically verifiable audit trails, ensuring compliance and transaction integrity.

The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for securely managing user authentication and wire transfer operations via a browser interface, comprising:
providing a browser interface implemented using a React-based frontend for user interaction, wherein the interface enables users to securely input and manage banking information through a responsive design, and communication between the frontend and backend services is encrypted using Transport Layer Security (TLS) to prevent unauthorized access to sensitive data;
implementing a User Microservice configured to perform multi-factor authentication (MFA) to verify the identity of users, wherein the microservice is integrated with AWS Cognito, and upon successful authentication, AWS Cognito generates a JSON Web Token (JWT), the JWT being transmitted back to the browser interface via TLS-encrypted channels, wherein the JWT is included in subsequent requests from the frontend in the Authorization Header for verification by the backend services;
providing a Wire Transfer Microservice configured to validate the JWT tokens received from the React frontend to confirm that the user's session is authenticated and valid by verifying the token's signature using AWS Cognito's built-in mechanisms, b. Perform Role-Based Access Control (RBAC) checks to authorize user actions for adding or managing bank account details based on predefined permissions;
storing up to five bank accounts per user within the Wire Transfer Microservice, wherein banking information, including account numbers and routing numbers, is transmitted over TLS-encrypted channels and further encrypted using AES SHA-256 symmetric encryption managed by AWS Key Management Service (KMS), the encrypted banking data being stored in a database with encryption at rest to ensure protection against unauthorized access;
facilitating secure requests for bank information, wherein users provide recipient contact details, and the Wire Transfer Microservice: transmits secure messages to recipients, including a link directing them to the platform, wherein recipients are required to undergo a secure authentication process including MFA before submitting their banking information, and encrypts and stores submitted bank information using AES SHA-256 encryption in a Quantum Ledger Database (QLDB) to ensure cryptographic verifiability and data immutability;
supporting secure sharing of bank information through a predefined sharing feature, wherein users access the feature after undergoing MFA authentication, and the shared banking information is encrypted during transmission, with machine learning-based validation checks applied to ensure data accuracy before sharing, and the system sends secure notifications to the intended recipient with MFA onboarding for access;
enabling users to initiate wire transfers through a Transaction Selection Interface, wherein: the system verifies inputs, such as transaction amount and recipient details, using a machine learning-based validation engine, performing checks for sufficient funds and confirming the legitimacy of the transfer, and multi-recipient wire transfers are supported, allowing users to select multiple recipients in a single one click transaction based on verified account balances;
providing real-time transaction status updates and notifications, wherein users are notified upon successful initiation and completion of wire transfers, and all transaction activities, including validations, banking data exchanges, and transfer operations, are securely logged by an Audit Microservice, with the logs stored in a Quantum Ledger Database (QLDB) for tamper-proof, cryptographically verifiable audit trails, ensuring compliance and transaction integrity.

2. A computer-implemented method for securely managing user authentication and wire transfer operations via a browser interface, the method being executed by a distributed computing system comprising at least one processor and a non-transitory computer-readable medium storing executable instructions, the method comprising the steps of:
providing a browser-based user interface implemented using a React framework executed on a client computing device, the interface enabling a user to securely input and manage banking information through a responsive design configured to adapt to multiple device viewports, wherein communication between the frontend and backend microservices is encrypted using Transport Layer Security (TLS) to prevent unauthorized access to sensitive data during transmission;
implementing a User Microservice executed by a backend server and configured to perform multi-factor authentication (MFA) to verify an identity of the user, wherein the User Microservice is integrated with Amazon Web Services (AWS) Cognito, and upon successful authentication, AWS Cognito generates a JSON Web Token (JWT) £ representing the authenticated session, the JWT being transmitted back to the browser interface via a TLS-encrypted channel, wherein subsequent requests from the frontend include the JWT in an Authorization Header for backend verification; ‘=
implementing a Wire Transfer Microservice executed by the backend server, the Wire Transfer Microservice being configured to: validate JWT tokens received from the React frontend by verifying the token's digital signature using AWS Cognito's built-in public key infrastructure (PKI); perform Role-Based Access Control (RBAC) checks to authorize user actions for adding, updating, or managing bank account details based on predefined user roles and permissions stored within the system; and store up to five bank accounts per user, wherein each account record includes encrypted banking information comprising account numbers and routing numbers, the information being encrypted using Advanced Encryption Standard (AES) with SHA-256 symmetric encryption keys managed by AWS Key Management Service (KMS), and stored in a database providing encryption-at-rest to ensure protection against unauthorized access;
facilitating secure recipient onboarding by transmitting secure communications including a link directing a recipient to the platform, wherein: the recipient undergoes an MFA process prior to submitting banking information; the submitted banking information is encrypted using AES SHA-256 encryption and recorded within a Quantum Ledger Database (QLDB) to provide cryptographic verifiability and data immutability; enabling secure sharing of banking information through a predefined sharing module accessible only after MFA verification, wherein: shared data is encrypted during transmission using TLS; machine-learning-based validation checks are applied to confirm data integrity and detect anomalies prior to data sharing; and secure notifications with MFA onboarding links are transmitted to authorized recipients for access;
enabling the user to initiate wire transfers via a Transaction Selection Interface, wherein: a machine-learning-based validation engine verifies transaction parameters, including transaction amount and recipient account legitimacy, and performs sufficiency-of-funds checks prior to authorization; and multi-recipient wire transfers are supported, enabling a user to select and process multiple authenticated recipients within a single one-click transaction operation;
providing real-time transaction status updates and notifications through the browser interface, wherein: the user is notified upon initiation and completion of wire transfers; and all transaction activities, validations, data exchanges, and transfer operations are securely logged by an Audit Microservice, the logs being recorded in a Quantum Ledger Database (QLDB) to create a tamper-proof, cryptographically verifiable audit trail ensuring transaction integrity and regulatory compliance;
wherein the method provides a technological improvement in the secure management and execution of online financial transactions by employing distributed microservices, cryptographically verifiable storage, and machine-learning-based data validation, thereby enhancing the integrity, security, and efficiency of user authentication and wire transfer operations beyond conventional manual or server-centric authentication systems.

3. A method for secure addition and management of bank account information implemented on a computing system, the method comprising:
obtaining, through a specialized computer system connected to the internet, a routing number and account number for bank account addition, wherein the system is configured to securely transmit and receive bank account details using encrypted communication protocols;
implementing machine learning algorithms and artificial intelligence models specifically trained to analyze and identify relationships between routing numbers and corresponding financial institutions, as well as to recognize common formats and patterns within account numbers, the system thereby improving the accuracy and efficiency of bank account data processing;
automatically identifying and correcting discrepancies in real time based on said analysis, wherein the machine learning models provide a technical solution to the problem of erroneous or incomplete bank account data entry by leveraging learned patterns to enhance data integrity during account addition;
employing machine learning-based anomaly detection techniques to minimize the likelihood of data entry errors, thereby improving the reliability and security of the member's bank account information, and providing a concrete improvement to data processing systems;
incorporating artificial intelligence-driven data validation mechanisms that ensure submitted bank information is accurate and complies with predefined security standards, wherein the validation occurs in real time and adapts to new patterns detected by the system, thereby enhancing the platform's ability to safeguard sensitive data;
automatically notifying members via a secure and encrypted communication channel, allowing members to access validated and encrypted bank details through the platform, where unauthorized access is prevented by a multi-factor authentication process;
utilizing a Quantum Ledger Database (QLDB) to store bank details in an immutable, cryptographically verifiable manner, thereby addressing the technical challenge of ensuring both security and traceability of sensitive financial information within the system;
applying machine learning models to assess and mitigate transaction risks associated with incoming bank account data, wherein the system flags suspicious or high-risk data in real time and prevents such data from being entered into the system, thus providing an improved mechanism for fraud detection and data validation;
providing a secure platform for sharing bank account information with verified users upon request, where the system automatically validates the recipient's credentials and uses machine learning algorithms to ensure the information is securely shared only with authorized individuals;
allowing members to initiate bank transfers through the platform, wherein the system validates the transfer request by checking for sufficient funds, verifying the accuracy of the recipient's information, and confirming the transaction status, all while providing real-time updates on the transfer progress;
utilizing an authentication mechanism that grants access to a member's bank details only after successful completion of a secure authentication process, thereby ensuring that sensitive bank information is accessible only to authorized individuals, and preventing unauthorized access;
automatically retrieving real-time bank balance information for a selected account via an authenticated request, ensuring that all sensitive data is managed securely and only accessible after verification;
validating bank transfers through a series of checks, including verifying that sufficient funds are available, confirming the validity of the transfer, and identifying any missing or incorrect inputs before executing the transaction, thereby improving the security and accuracy of bank transfers within the system;
automatically notifying the member of the status of the bank transfer and providing a detailed overview of the transaction, including the recipient's information, transfer amount, and real-time status updates, wherein the system enhances user experience and provides transparency for all financial transactions.
